(19) United States
(12) Patent Application Publication
(10) Pub. No.: US 2004/0116123 A1
(43) Pub. Date: Jun. 17, 2004

(54) Method and system for interference measurements in a telecommunication system

(76) Inventors: Krister Sundberg, Stockholm (SE); Anders Hedlund, Skelleftea (SE)

Correspondence Address: BURNS DOANE SWECKER & MATHIS L L P, POST OFFICE BOX 1404, ALEXANDRIA, VA, 22313-1404, US

(21) Appl. No.: 10/467,855

(22) PCT Filed: Mar. 6, 2002
(86) PCT No.: PCT/SE02/00391

(30) Foreign Application Priority Data
Mar. 6, 2001 (SE) 0100740-0

(51) Int. Cl. H04Q 7/20

(52) U.S. Cl. 455/450

(57) ABSTRACT

The present invention relates to an apparatus and a method for measuring interference levels in a telecommunication system comprising a radio base station communicating with at least one in-house mounted transceiver, the transceiver defining a communication range in which it is responsible for handling, communication terminals, such as mobile phones or computer terminals. By means of at least one scanner the apparatus synchronises with transmitted information from the base station to the transceiver in a time regime. The scanner is connected to measurement means for measuring the interference level on transmitted information and the measurement means is adapted to compare measured interference levels with each other an thereby improve transmission between the base station and the transceiver on a favourable frequency, whereby the problem of interference on allocated traffic channels is alleviated.

### TECHNICAL FIELD OF THE INVENTION

This invention generally relates to a method and system for measuring interference in a telecommunication system. More in particular, the invention relates to interference measurements primarily, but not exclusively, on allocated and non-allocated traffic channels.

### BACKGROUND OF THE INVENTION

The last few years, integration of data communication and telecommunication technologies has been discussed among people, who used to work in either of the technical fields. The integrating phenomenon is also known as the convergence of communication technologies, and a lot of effort is currently put down in scientific communities and in global research and development organisations for realising the concept of the Wireless Internet, a way of accessing information contained within the Internet no matter when and where the information is to be accessed.

One way of realising the concept of immediate and constant access to the Internet in office buildings without cables and wires that limit the dynamics of the office, is to combine wireless radio communication technology, such as the GSM, with an Internet protocol (IP) based local area network (LAN) environment. Such systems already exist today, although in most cases they are not yet fully operative. The functionality of such systems may be similar to that of GSM, but it includes utilisation of Internet protocol transmission, instead of prior art transmission technologies.

Physical properties of radio transmission depend on many constantly changing parameters. Network and frequency planning must be performed regularly, and often manually in order to maintain a functional telecommunication system. Another reason for planning networks is to avoid internal and external conflicts between interfering radio channels leading to poor transmission performance and cut-offs. Predicting the radio transmission in a network by calculating the properties or by estimating them can be very complex in many environments, and in-house radio transmission is no exception. The in-house situation is rather the reverse, since radio transmission properties change rapidly inside a building, due to additional irregularities that repeatedly require measurements and maintenance of allocated frequencies. Due to the difficulties in maintaining favourable conditions over longer periods of time for radio transmission, physical conditions for radio transmission tend to be poor and unpredictable in many office buildings.

For the reasons stated above, periodic and systematic maintenance of frequencies for use is required in a radio transmission network for mobile telephony. In a situation with only one vendor in a certain geographical region, which means that all base stations and control equipment originates from the same provider, several maintenance solutions are conceivable. For instance a macroscopic solution for handling and monitoring the communication network including measurement of transmission properties and maintenance is possible. Using such a macroscopic tool makes it possible to gather information also from neighbouring sites and present an optimised network plan. However, an absolute requirement for presenting the optimised network plan is that collected information is compatible, and in practice this means that the entire equipment must be of the same brand, as different brands build their sites differently and use proprietary transmission schematics and protocols. Also transmission protocols between nodes often differ slightly from vendor to vendor, and due to the increased complexity and competition between vendors, it is unrealistic the macroscopic tools shall be able to consider all these additional incompatibilities and difficulties in analytical manners. Handling the additional complexities associated with different standards in used communication protocols would require an immense computational capacity, which is not possible today.

Hence, there is a need for an improved technique for handling maintenance of a communication network including tight frequency planning, in urban or other densely populated geographical areas.

### SUMMARY OF THE INVENTION

It is therefore an object of this invention to provide an improved stand-alone tool for the optimisation of frequencies utilised in a communication network. Another object is to overcome problems associated with inherent limitations of traditional cell planning tools. Two examples among others of such tools for cell and frequency planning are NOX (Network Optimization eXpert) and FOX (Frequency Optimization eXpert).

The present invention overcomes the problems associated with prior art technology by means an apparatus and a method for measuring interference levels in a telecommunication system comprising a radio base station communicating with at least one in-house mounted transceiver, the transceiver defining a communication range in which it is responsible for handling communication terminals, such as mobile phones or computer terminals, characterised in that

at least one scanner is provided with means for synchronising with transmitted information from the base station to the transceiver in a time regime;

the scanner is connected to measurement means for measuring the interference level on transmitted information; and

the measurement means is adapted to compare measured interference levels with each other and thereby improve transmission between the base station and the transceiver on a favourable frequency.

One of the advantages of the invention is that is provides the operator with a tool for both setting up a data- and telecommunication network in the initial phase and after the establishment, it is a tool for maintenance and periodical re-planning of the network. In particular the interference measurements on allocated traffic channels, that are made possible by means of the invention, are an absolute prerequisite for performing maintenance of the communication network. The possibility of comparing interference levels of allocated and non-allocated traffic channels is beneficial for the operator that runs a communication network.

The present invention is therefore beneficial for the operator in particular. The communication network can be monitored more closely and the operation of the network can be optimised in any environment, which is advantageous. Extremely important positions within the network, sometimes called “hot-spots” can be provided with additional network capacity, used frequencies can be less interfered and the strongest of neighbouring sources of interference can both be found and avoided. By means of the present invention, the transmission quality in a general sense in a communication network is enhanced.

### BRIEF DESCRIPTION OF THE DRAWINGS

The features, objects, and further advantages of this invention will become apparent by reading this description in conjunction with the accompanying drawings, in which like reference numerals refer to like elements and in which:

FIG. 1 schematically illustrates an office building with an in-house communication system according to the present invention.

FIG. 2 depicts a flow chart for estimating interference levels of allocated as well as non-allocated traffic channel frequencies in order to finding favourable transmission frequency.

### DETAILED DESCRIPTION

The following description is of the best mode presently contemplated for practising the invention. The description is not to be taken in a limiting sense, but is made merely for the purpose of describing the general principles of the invention. The scope of the invention should be ascertained with reference to the issued claims.

It will be appreciated by those of ordinary skill in the art that this invention can be embodied in other specific forms without departing from its essential character. The embodiments described below should therefore be considered in all respects to be illustrative and not restrictive. For example, although described with reference to a GSM system employing a fixed cellular terminal, the invention is also applicable in other types of communication systems. These other types of communication systems are for example GSM (Global System for Mobile communication) combined with any of the standardised modulation techniques GPRS (General Packet Radio Service), EDGE (Enhanced Data rates for Global Evolution) or other future telecommunication standards based on the GSM. Moreover, measurements of the physical channels, i.e. frequencies like broadcast control channel carriers, BCCH, and traffic channel carriers, TCH, are not equal to the logical channels as such. However, this is readily understood by the person who is skilled in the art of telecommunication.

In a digital telephony system for mobile communication based on TDMA (Time Division Multiple Access), information is transmitted within certain time slots in a sequence of frames. These frames are transmitted between handling radio base stations and mobile terminals, such as cellular phones or other communication means, and the information conveyed between nodes and terminals may be either voice traffic or data traffic depending on the nature of the connection. However, the transmitted information can also be for control- or synchronisation purposes, which information is transmitted over so-called control channels and this information does not interfere with the other kinds of transmitted information.

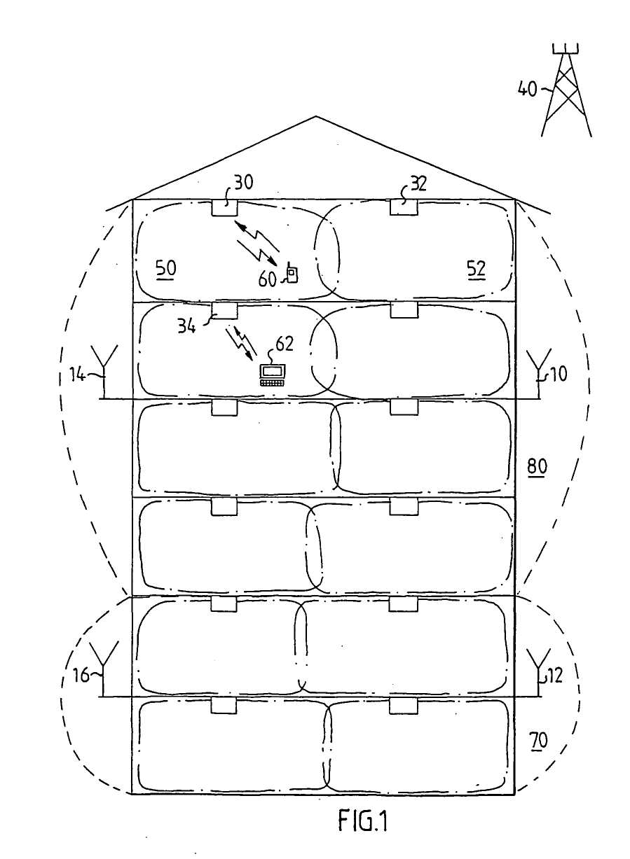

With reference to FIG. 1, a telecommunication system according to the present invention is depicted. An office building equipped with in-house mobile telecommunication facilities is illustrated, which office building is having a radio base station 40 situated at close distance. Well planned in-house mobile telecommunication equipment is supposed to facilitate higher transmission rates than the average transmission rates outdoors and office personnel can be provided with access to corporate information via wireless LAN (local area network), preferably with sufficiently high data transmission rates. Therefore, a simplified office management with improved efficiency can be achieved. Another advantage is that the office dynamics increases significantly when installation of electronic equipment and otherwise tedious wiring is made unnecessary.

Furthermore with reference to FIG. 1, at least one radio transceiver 30, 32, 34 for communication with electronic terminals, such as computers 62 and mobile phones 60, is installed in the building. According to the illustration, two transceivers are installed per floor within the whole office building, which transceivers operate as relaying small sized radio base stations. A cell 50, 52 is created by each transceiver, which cell is defined by the space within the building where the transceiver has better conditions for radio communication with electronic communication terminals of various kinds than any other transceiver, and thus the space where the transceiver has the overall responsible for handling radio transmission to and from terminals. An example with direct reference to FIG. 1 is cell 64, which cell is handled by the transceiver 34 and connection is established with the computer terminal 62. In most cases, the transceivers are in bi-directional contact with the radio base station 40 via at least one antenna (not shown), which antenna preferably is placed on the roof of the office building within line-of-sight to the radio base station for obtaining a favourable link budget.

Cells are defined by the transceiver that handles devices within that particular cell. However, associations of cells can also be organised. Associations of cells may be organised analytically, but also in a more empirical way. Cells situated in office floors near the street level are more interfered by street level radio transmission than cells of the floors higher up in the building. Therefore, if cells are to be associated for common treatment because their conditions for radio transmission are similar, the associations of cells have to be made with regards to the positions of the cells respectively. Generally, an association 70 near the street level is made of only a few cells, for instance those of two floors, and an association 80 higher up in the building is made of a larger number of cells, for example as shown in FIG. 1 with eight separate cells of four floors. At least one radio frequency scanner 10, 14 is placed in each cell association. The at least one radio frequency scanner is placed inside the association where the interference reaches its maximum, i.e. as near corners or other projections of the building as possible. The scanner, or scanners if applicable, is located where the interference reaches its maximum to be able to measure the interference levels from a so-called worst-case perspective. The scanner is a tool for supervising the interference situation and thereby support when analysing the neighbour relations. Connected to the radio frequency scanner is a number of various instruments such as a scanner manager and tools for measurement, evaluation and presentation.

In the following, many notations of channels and codes are made while referring to GSM standards. Those standards are open source information well-known and understood be the person skilled in the art of telecommunication systems. However, and mainly for clarity reasons, explanations are added to certain specifications of this text where appropriate. Important to keep in mind is that all measurements are carried out on a burst level. Neighbour relations are found by first identifying the strongest broadcast control channels, BCCHs, and then decoding the cell global identity, CGI. The strongest broadcast control channels in terms of signal strength are considered to be the strongest frequencies at which the base station identity code, BSIC, can be decoded. When gathering interference data and presenting the interference situation, it is important that the output gives a true picture of the interference and that the values presented are stable. This stability is achieved by filtering the interference values before the presentation. The filter used for filtering the interference values may for instance be an exponential recursive filter.

For the interference measurement system to be functional, the interference situation must be measured and compared in a similar fashion for all relevant frequencies, i.e. both for allocated frequencies and non-allocated frequencies. The interference situation on non-allocated frequencies is found in a straightforward manner by measuring the transmitted signal strength, SS, directly. However, measuring allocated frequencies, like for instance frequencies of broadcast control channels, BCCHs, and traffic channels, TCHs, is not as simple, because of the transmitted wave energy originating from both interference signal strength and carrier wave signal strength.

In the case of broadcast control channels BCCHs, which channels are transmitting continuously, the interference can be identified by measuring both the signal strength, SS, and the carrier to interference ratio, C/I, on a burst level: For measuring the appropriate bursts, a requirement is that the scanner 10, 12 first has been synchronised with the broadcast control channel, BCCH, which is subjected to measurement. An approximation for the interference, I, is:

$$I = SS - \frac{C}{I} \qquad ( 1 )$$

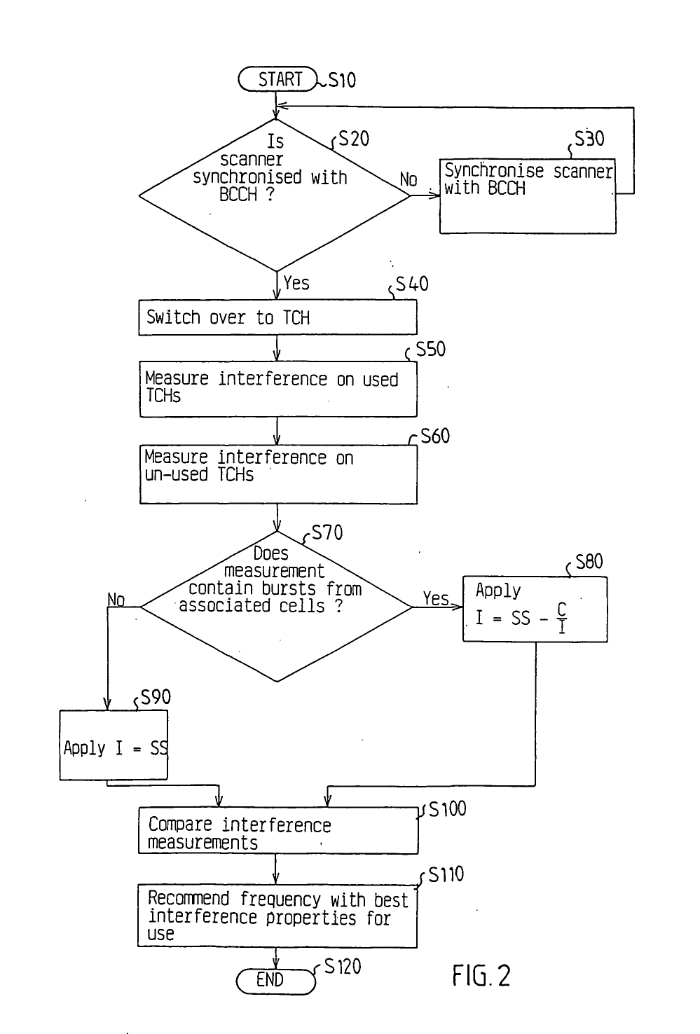

The above methods are not applicable for allocated traffic channels, TCHs, since allocated TCHs are not transmitting signals continuously, on which signals the interference situation can be measured and estimated. Therefore, according to the present invention, another method is suggested for measuring the interference on allocated traffic channels. The method will be described sequentially below with reference to FIG. 2.

The steps in the flowchart of FIG. 2 starts (S10) with and inquiry of whether the radio frequency scanner 10, 12 is synchronised with the broadcast control channel, BCCH. If not, the scanner synchronises (S30) with the broadcast control channel, BCCH, and otherwise if it is synchronised, the scanner switches over (S40) to one traffic channel frequency after the other. The fact is used that the broadcast control channel, BCCH, is synchronous with the traffic channels, TCHs. Measurements can be done on any number of traffic channel frequencies during a predetermined time period, which time period is set by the operator. Conceivable measurements to be done are signal strength (SS), carrier to interference ration (C/I) and decoding of the training sequence code, TSC. The decoding is done by a one to one mapping of to the base station colour code, BCC. If applicable, another mapping can be done by utilising the cell global identity, CGI, with the corresponding training sequence code, TSC. Interference is measured (S50) on used traffic channels but is also measured (S60) on unused traffic channels. These measurements are followed by an estimation, which is built on the preceding interference measurements, of whether bursts are recognised (S70) during the measurements from associated cells, whereby the applicable relations for interference estimation can be chosen when evaluating the interference situation of each measurement respectively.

In case bursts from an associated cell have been recognised, the approximate relation (1) stated above is applied (S80) for obtaining a comparable interference level. Otherwise, i.e. no bursts from associated cells have been found, the interference level equals the signal strength, i.e. I=SS can be applied (S90) when comparing (S100) measured interference levels. More in detail, the interference should be estimated as being equal to the signal strength, SS, for measurements without training sequence code, TSC, and according to the above stated relation (1) if the measurement contains carrier to interference ratio, C/I, and training sequence code, TSC.

Having established comparative interference measurements, the transmission frequency with having the most favourable signal properties can be recommended (S110) for use. After this recommendation of which frequency to use, the sequence ends (S120).

A system according to the present invention also measures and estimates interference levels, whereby a presentation and recommendation according to the above stated relation (1) is made possible. The sequence leading to a presentation of the interference situation generally follows a sequence similar to the one described above with reference to FIG. 2. Furthermore, by means of the inventive method and system, the operator of the communication network is able to evaluate and find the neighbour cell relations by identifying the strongest neighbours for the at least one associated cell. The scanners 10, 12 help finding the most favourable of the transmitted frequencies where the base station identity code, BSIC, can be decoded. This leads to subsequent possibilities to decode also the cell global identity, CGI.

In theory, the possibility remains that an associated cell and one of its neighbouring cells has the identical training sequence codes, TSCs. In such a case, although theoretically, the scanner 10, 12 would interpret occurring and recognised bursts as bursts from the own associated cell. Measurements of identical codes from different sources that could not be separated would be misleading and therefore the system according to the present invention is instructed to do the same measurements on the idle. frame. If also the idle frame would contain bursts with the right training sequence codes, TSCs, the frequency is excluded from use and hence, no misleading interference measurements may occur.

1. An apparatus for measuring interference levels in a telecommunication system comprising a radio base station (40) communicating with at least one in-house mounted transceiver (30, 32), the transceiver (30, 32) defining a communication range in which it is responsible for handling communication terminals (60, 62), such as mobile phones or computer terminals, characterised in that
at least one scanner (10, 12) is provided with means for synchronising with transmitted information from the base station (40) to the transceiver (30, 32) in a time regime;
the scanner (10, 12) is connected to measurement means (not shown) for measuring the interference level on transmitted information; and
the measurement means (not shown) is adapted to compare measured interference levels with each other and thereby improve transmission between the base station (40) and the transceiver (30, 32) on a favourable frequency.

2. An apparatus in a telecommunication system according to claim 1, characterised in that
after synchronisation, the scanner (10, 12) is adapted to switch over from a first monitored frequency to a second monitored frequency.

3. An apparatus in a telecommunication system according to claim 2, characterised in that
the first monitored frequency is a broadcast control channel (BCCH) carrier and the second monitored frequency is a traffic channel (TCH).

4. An apparatus in a telecommunication system according to anyone of the preceding claims, characterised in that
a plurality of communication ranges, i.e. cells, in which one transceiver each is responsible for handling communication terminals (60, 62), are grouped together into associations of cells.

5. An apparatus in a telecommunication system according to claim 1, characterised in that
the at least one scanner (10, 12) of the associated cell is placed on one of the building projections where the interference situation is difficult.

6. An apparatus in a telecommunication system according anyone of the preceding claims, characterised in that
a scanner manager (not shown) is adapted to handle measurement information from each scanner (10, 12) and forward the information to evaluation means (not shown).

7. An apparatus in a telecommunication system according to anyone of the preceding claims, characterised in that
a filter (not shown) is adapted to stabilise measurement values before presentation.

8. An apparatus in a telecommunication system according to claim 7, characterised in that
the filter (not shown) being an exponential recursive filter is adapted to stabilise measurement values before presentation.

9. A method for measuring interference levels in a telecommunication system, comprising a radio base station (40) communicating with at least one in-house mounted transceiver (30, 32), the transceiver (30, 32) defining a communication range in which it is responsible for handling communication terminals (60, 62), such as mobile phones or computer terminals, the method characterised by the steps of:
synchronising at least one scanner (10, 12) in a time regime with transmitted information from the base station (40) to the transceiver (30, 32);
measuring the interference level on transmitted information; and
comparing measured interference levels with each other and thereby improving transmission between the base station (40) and the transceiver (30, 32) by utilising a favourable frequency.

10. A method for measuring interference levels in a telecommunication system according to claim 9, further characterised by the step of:
switching over from a first monitored frequency being a broadcast control channel (BCCH) carrier to a second monitored frequency being a traffic channel (TCH).

11. A method for measuring interference levels in a telecommunication system according to claim 9, further characterised by the step of:
measuring the interference level of transmitted information being both allocated traffic channels (TCH) and non-allocated traffic channels.
